(19) United States
(12) Patent Application Publication
(10) Pub. No.: US 2019/0068478 A1
(43) Pub. Date: Feb. 28, 2019

(54) SYSTEM AND METHOD FOR COLLECTING PERFORMANCE AND USAGE DATA FROM COMPUTING DEVICES

(71) Applicant: Lakeside Software, Inc., Bloomfield Hills, MI (US)

(72) Inventors: Daniel Salinas, Birmingham, MI (US); Benjamin Wilson Murphy, Ann Arbor, MI (US); Kartikeya Iyer, Millington, MI (US); Robert William Koehler, Southfield, MI (US)

(21) Appl. No.: 16/114,444

(22) Filed: Aug. 28, 2018

Related U.S. Application Data
(60) Provisional application No. 62/551,046, filed on Aug. 28, 2017.

(51) Int. Cl. H04L 12/26; H04L 29/06; G06F 9/451

(52) U.S. Cl. CPC H04L 43/106; H04L 67/38; H04L 43/04; G06F 9/452; H04L 43/022

(57) ABSTRACT

An edge computer or thin client computing device is connected, via a virtual desktop infrastructure (VDI) session data channel, to a host/server computing device on which is hosted at least one of an application or a desktop for the edge computer/thin client. A collector software component executing on the edge computer/thin client establishes a sub-channel (virtual channel) connection to a companion receiver software component executing on the host/server device. The collector component collects and transmits telemetry data about the edge computer/thin client over the now-established virtual channel to the receiver component, which processes and stores the data in a database associated with a workspace analytics system. The collector component oversamples relative to a native sampling rate of the workspace analytics system wherein the receiver component stores an average of the received data stream in the database at a time synchronized with the native timing of the workspace analytics system.

### CROSS-REFERENCE TO RELATED APPLICATIONS

This application claims the benefit of U.S. provisional application No. 62/551,046, filed 28 Aug. 2017 (the '046 application). The '046 application is hereby incorporated by reference as though fully set forth herein.

### BACKGROUND

### a. Technical Field

The present disclosure relates to a mechanism for collecting performance and usage data from computing devices such as edge computers or thin client computing devices.

### b. Background Art

This background description is set forth below for the purpose of providing context only. Therefore, any aspects of this background description, to the extent that it does not otherwise qualify as prior art, is neither expressly nor impliedly admitted as prior art against the instant disclosure.

It is known to provide a workspace analytics system adapted to manage information relating to computers in a distributed computer network, such as seen by reference to U.S. Pat. No. 7,865,499 entitled “SYSTEM AND METHOD FOR MANAGING INFORMATION FOR A PLURALITY OF COMPUTER SYSTEMS IN A DISTRIBUTED NETWORK”, assigned to Lakeside Software, Inc., the common assignee of the instant application. Generally, a workspace analytics system may provide a tool that allows analysis of user behavior, hardware and software utilization, health and performance and component dependencies in complex computing environments. Accurate and timely information provided by such systems allows its users, such as information technology (IT) professionals, to effectively direct spending such that the best return on investment may be achieved while simultaneously improving the end user experience.

Increasingly, however, personal computers have morphed into smaller, more purpose-built devices, which may typically be built of hardware that may be less capable and powerful than that running on a conventional server machine. Such devices either do not have the computing resources to run a fully-featured workspace analytics monitoring solution, or are different enough that they require specialized monitoring different from that utilized on more conventional computer systems. Examples include edge computing devices and thin client computing devices.

In addition, these devices are likely to be used in more varied and disparate environments where the requirements for custom configuration must be minimal. Further, in addition to being utilized in conventionally networked operational environments, these devices may also be utilized in an operational environment, such as geographically separated locations, in which the communication channels between the computing device (e.g., edge computing device) and the receiving device may comprise wide area network (WAN) and/or metropolitan area network (MAN) links, which may traverse a part of the public Internet rather than directly being point-to-point. Such devices may also be utilized in an environment where some of the computer systems are comprised of elements of a “cloud”, in other words, a computing-infrastructure and software model for enabling ubiquitous access to shared pools of configurable resources (e.g., computer networks, servers, storage, applications and services), and which can be rapidly provisioned with minimal management effort, often over the Internet. In such situations, the need to create, configure and secure a separate communications channel specifically for the purpose of monitoring and gathering telemetry data may be logistically and physically infeasible for a number of reasons.

It would therefore be desirable to provide a system and method for collecting performance and usage data that minimizes and/or eliminates one or more of the above-mentioned challenges.

The foregoing discussion is intended only to illustrate the present field and should not be taken as a disavowal of claim scope.

### SUMMARY

In an embodiment, a method for collecting and transmitting information associated with a client computing device to a host computing device is provided. In an embodiment, the client computing device may be an edge computer or a thin client computing device. The host computing device hosts at least one of an application and a desktop, and provides data such as representative of the user's desktop or application—for rendering on the client computing device-which is transmitted to the client computing device over a data channel. In an embodiment, the data channel may be a virtual desktop infrastructure (VDI) protocol-compliant data channel. The method includes establishing a sub-channel that is associated with the data channel for purposes of communication between the client computing device and the host computing device. The method further includes collecting information on and associated with the client computing device at predetermined times. In an embodiment, the collecting of information is performed by a collector (software) component that executes on the client computing device. The method further includes transmitting the collected information from the client computing device, using the established sub-channel, to the host computing device. In an embodiment, the host computing device includes a receiver software component, which executes thereon, for receiving the transmitted information. Additionally, the method includes updating a database of a workspace analytics system using the received information.

An apparatus for collecting and transmitting information associated with a client computing device is also presented.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is a simplified block diagram view of an apparatus for collecting and transmitting information associated with a client computing device, in an embodiment.

FIG. 2 is a simplified flowchart diagram of a method for collecting and transmitting information associated with the client computing device of FIG. 1, in an embodiment.

FIG. 3 is a simplified timing diagram showing oversampling by a collector software component executing on the client computing device information, relative to a sampling interval of a workspace analytics system, in an embodiment.

FIG. 4 is a simplified block diagram view showing a plurality of timestamped transmissions of client computing device information (e.g., telemetry data).

### DETAILED DESCRIPTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Before proceeding to a detailed description of embodiments consistent with the present disclosure, a general, functional overview will first be set forth. Embodiments of the present disclosure are configured to collect information, such as performance and usage data, from a client computing device, such as a thin client computing device, and then to transmit the collected data to a host computing device—typically a more capable device—using industry standard communication protocols. The host computing device is configured to store the received data to a workspace analytics system (e.g., in a constructed embodiment, a Lakeside Software SysTrack database structure).

Once the collected data has been stored in the database structure, the workspace analytics system can provide detailed and wide-ranging analysis of the collected data, both for individual devices and across large numbers of monitored devices. The collection mechanism, in embodiments, comprises a collector software component and a receiver software component and which can be ported to different computer operating systems allowing it to monitor a wide range of computing devices. Several different communications channels can be utilized as well, allowing for configuration-free connections between the thin client computing device (hereinafter sometimes called the “collector” or “collector device”) and the host/server computing device (hereinafter sometimes called the “receiver” or “receiver device”). By utilizing existing communication channels, embodiments consistent with the present disclosure can take advantage of pre-existing network configuration(s), security policies, and network firewall settings already in place within an organization, thereby avoiding the need for additional or separate configuration to enable such performance and usage data collection.

Additionally, in embodiments, a number of particular features include, without limitation, any one or more of the following features. The ability to gain end-to-end visibility for a virtual session by having a synchronized version of the system/app/user behavior from both sides of the link (i.e., the hosting side and the thin client side). Significantly, embodiments can provide the ability to have both views in an integrated form.

The ability to interrogate thin client computing device performance data even without actual access to the thin client computing device across a network.

The ability to diagnose certain kinds of problems that cause issues on the hosting side but are caused by the thin client computing device side.

The ability to collect and store the data (e.g., telemetry data) without any additional networking needs (i.e., without any additional needs beyond an already-available connection between the thin client computing device and the host/server/virtual machine) and, significantly, without storing the collected data on the thin client computing device. This is significant since the thin client computing device may be resource limited.

The ability to work and/or operate with any kind of thin client computing device or virtualized thin client computing device.

The ability to work and/or operate with any virtual desktop infrastructure (VDI) or XenApp (i.e., Citrix) platform on the hosting side.

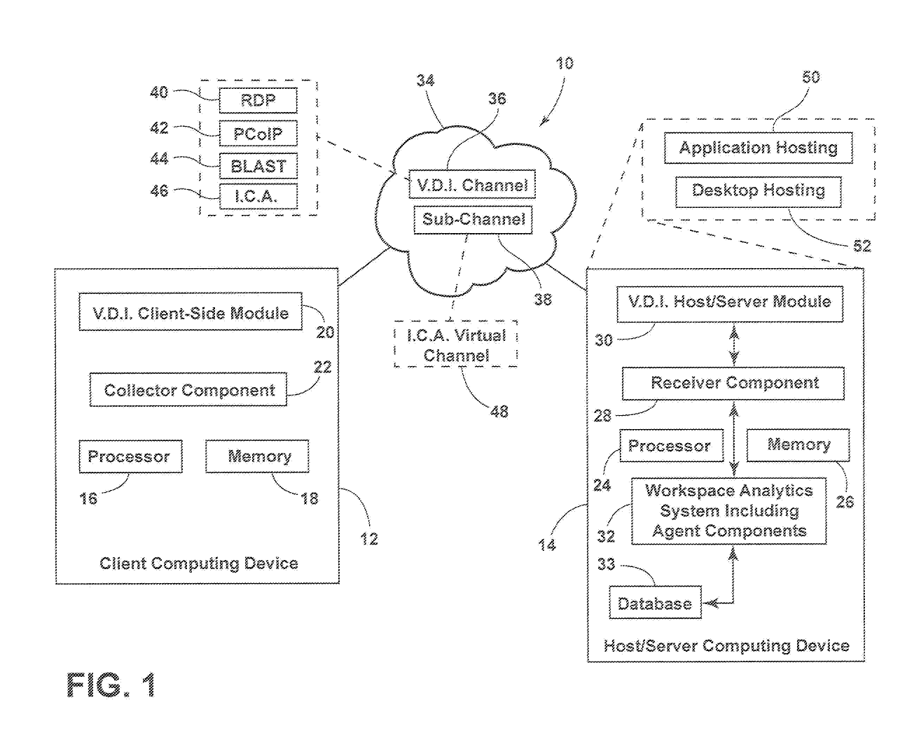

Referring now to the drawings wherein like reference numerals are used to identify identical or similar components in the various views, FIG. 1 is a simplified block diagram view of a system 10 for enabling the collecting of information associated with a client computing device 12, such as an edge computer or a thin client computing device, which collected information can be transmitted to a host/server computing device 14.

The client computing device 12 includes an electronic processor 16, a memory 18, a Virtual Desktop Infrastructure (VDI) client-side module 20 and a collector software component 22. The host/server computing device 14 includes an electronic processor 24, a memory 26, a receiver software component 28, a VDI host/server module 30, a workspace analytics system 32 (including an agent component) and the associated database identified by reference numeral 33.

The processor 16 may include processing capabilities as well as an input/output (I/O) interface through which processor 16 may receive a plurality of input and generate a plurality of outputs. The memory 18 is provided for storage of data and instructions or code (i.e., software) for processor 16. Memory 18 may include various forms of non-volatile (i.e., non-transitory) memory including flash memory or read only memory (ROM) including various forms of programmable read only memory (e.g., PROM, EPROM, EEPROM) and/or volatile memory including random access memory (RAM) including static random access memory (SRAM), dynamic random access memory (DRAM) and synchronous dynamic random access memory (SDRAM). The foregoing applies equally, in general, to the processor 24 and the memory 26, except for the generality that in many embodiments, the computing (processing) capability of the host/server computing device 14 will be significantly more than that of the client computing device 12.

The memory 18 stores executable code in the form of both the VDI client-side module 20 and the collector software component 22—the component 20 being configured to perform/facilitate the collection and transmission of information (e.g., telemetry data) associated with the client device 12. The memory 26 stores executable code in the form of the receiver software component 28 and the VDI host/server module 30.

It should also be understood that in the client computing device 12, the electronic processor 16 is configured generally to execute software defining the target platform and operating system, including but not limited to a Windows-based, Linux-based, and/or macOS based edge computer and/or thin client, although it should be appreciated that other platforms, such as smart cellular telephones (e.g., Android, IOS) may be included as well. In the host/server computing device 14, the processor 24 is also configured generally to execute software defining the platform and operating system including but not limited to a Windows-based and/or Linux-based computing devices, although variations are possible (e.g., macOS).

With continued reference to FIG. 1, the host/server computing device 14 further includes the workspace analytics system 32 and database 33. In an embodiment, the workspace analytics system 32 and associated database 33 may be a commercial product available under the trade designation SYSTRACK from Lakeside Software, Inc., Bloomfield Hills, Mich. USA. In an embodiment, the SYSTRACK analytics platform provides enterprise IT with the business intelligence to address a broad set of operational and security requirements, empowering them to make better decisions, dramatically improve productivity and reduce costs. The SYSTRACK analytics platform performs complex IT tasks like user auditing, performance monitoring, change management, event management, latency and end-user experience management, application resource analysis, chargeback, virtualization assessment and planning, application pool design, automated power management, and many others. The SYSTRACK analytics platform provides all of these features in both web report and interactive forms. Further, the SYSTRACK analytics platform integrates many management disciplines into a unique, comprehensive management console. The SYSTRACK analytics platform seamlessly manages virtualized desktops, virtualized servers, terminal servers and physical systems to provide an end-to-end view of the environment. The SYSTRACK analytics platform supports the complete range of deployments, from physical environments to partially/fully virtualized environments, to cloud computing.

The SYSTRACK platform is configured generally to monitor personal computers, server computers, and even virtual machines running inside a hypervisor, for example. The SYSTRACK platform furthermore can monitor Windows-based computers, macOS-based computers, and Linux-based computers. Further details of an exemplary workspace analytics system may be seen by reference to U.S. application Ser. No. 11/268,012 (the '012 application), now U.S. Pat. No. 7,865,499, entitled “SYSTEM AND METHOD) FOR MANAGING INFORMATION FOR A PLURALITY OF COMPUTER SYSTEMS IN A DISTRIBUTED NETWORK” and U.S. application Ser. No. 15/629,189 (the '189 application), published as US PG PUB 2018/0060422, entitled “METHOD AND APPARATUS FOR NATURAL LANGUAGE QUERY IN A WORKSPACE ANALYTICS SYSTEM”. The '012 application and the '189 application are both hereby incorporated by reference as though fully set forth herein.

Remote Display/Virtual Desktop Infrastructure Protocol(s).

A remote display protocol is a set of data transfer rules that enable an application or desktop to be hosted at one place, for example on one computing device but to be displayed on a client's screen/display at another location (e.g., the client computing device 12). For example, FIG. 1 shows in block form an application 50 to be hosted and/or a desktop 52 to be hosted. A so-called Virtual Desktop Infrastructure (VDI) is a virtualization technology wherein a desktop operating system can be hosted on a centralized host/server computing device and then accessed at the client computing device.

As shown in FIG. 1, a conventional VDI implementation includes at least a VDI host/server-side module 30 and a client-side VDI module 20, which are configured to establish a remote session through a communication connection or link 36 over a network 34 (e.g., LAN, WAN, MAN, Public Internet, etc.), where at least one of an application program or a desktop is hosted (executed) on the host/server and the output/display of that execution is rendered on the client computing device, which requires transmission of data representative of the output/display to be transmitted over the connection 36. As indicated in FIG. 1, the connection 36 can take the form of a VDI data channel 36.

In an embodiment, the VDI platform/protocol, which comprises the modules 20, 30 in FIG. 1, may be any one of several commercial products available under various trade designations, including without limitation: (i) Remote Desktop Protocol (RDP)/Remote Desktop Services from Microsoft, Redmond, Wash., USA, shown as block 40 in FIG. 1; (ii) PC over IP (PColP) from Teradici, Burnaby, British Columbia, Canada, shown as block 42 in FIG. 1; (iii) Blast/Blast Extreme from VMware, Palo Alto, Calif., USA, shown as block 44 in FIG. 1; and (iv) Independent Computing Architecture (ICA) from Citrix Systems, Fort Lauderdale, Fla., USA, shown as block 46 in FIG. 1. In an embodiment, the client-side module 20 and the server-side module 30 may comprise a commercially available products involving a Citrix remote desktop solution and comprising a Citrix Receiver product as the client-side module 20 and a XenApp/XenDesktop Server product as the server-side module 30. It should be appreciated client-side module 20 and host/server-side module 30 may take a wide variety of other forms according to other remote access protocol implementations, including VDI protocols, now known or hereafter developed.

With continued reference to FIG. 1, an embodiment of the present disclosure includes two software components, namely, the collector software component 22 and the receiver software component 28. In the illustrated embodiment, the collector component 22 and the receiver component make use of an industry standard communication channel available in the Citrix ICA protocol known as a virtual channel, which is shown in FIG. 1 as an ICA virtual channel 48. The collector component 22 and the receiver component 28 use the virtual channel, when established, to transmit collected information associated with the client device 12 (using the collector component 22) to the receiver component 28. Virtual channels are typically utilized in a Virtual Desktop Infrastructure (VDI) environment where the desktop display of a user's computing system is sent from the physical computer system (i.e., the receiver component) running this desktop session over a network communication channel to the edge or thin client computing device (i.e., to the collector component). The VDI channel 36 is established via conventional, pre-existing communications protocols that allow the display of a VDI remote desktop session hosted on the device 14 to be displayed (and interacted with by the user) on the user's client computing device 12.

The collector component 22 comprises executable software/code stored in memory 22, which when executed by the processor 16 is configured to establish, in coordination with the receiver component 28, a sub-channel 38 (e.g., the ICA virtual channel 48 mentioned above) over the main data communications link/channel 36 that is already set up between the client computing device 12 and the host/server computing device 14 by virtue of the client-side and server-side modules 20, 30. The collector component 22 is further configured, when executed by the processor 16, to collect information associated with the client computing device 12 at predetermined times (more on timing below) and to facilitate transmitting the collected information to the host computing device 14 using the established sub-channel 38 (i.e., again, the ICA virtual channel 48 in the illustrated embodiment).

The receiver software component 28 also comprises executable software/code and is stored in memory 26, which when executed by the processor 24 is configured to establish, in coordination with the collector component 22, the sub-channel 38 (e.g., an ICA virtual channel 48). The receiver component 28 is further configured, when executed by the processor 24, to receive—at the host/server device 14—the collected information that was transmitted from the client device 12, and to interact with an agent component of the workspace analytics system 32 in order to update the database 33 using the received information.

It should be appreciated that while the instant description makes reference to a single client computing device 12, the present disclosure is not so limited. For example, the collector software component 22 may be deployed to a plurality of client computing devices 12ᵢ, including different kinds of client computing devices. Moreover, in this case, the receiver component 28 may be further configured to receive the respective, collected information from each of the plurality of client devices 12ᵢ via the respective collector component 22ᵢ and to interact with the agent component of the workspace analytics system 32 to update the database 33 with a respective plurality of datasets, using all the received information from the plurality of client devices 12ᵢ.

In an embodiment, both the client-side collector component 20 and the server-side receiver component 28 may be written in a cross-platform programming language for deployment flexibility on a wide variety of different platforms, such as by using the C++ programming language that may be compiled for a wide variety of devices that support the C++ programming language. For example, known targets computing devices include Windows-based devices and Linux-based devices, although it should be understood that the embodiment is fundamentally operating system (OS) independent. In an embodiment, the collector component 22 will be available on a wide array of devices 12 (i.e., the wide array of different thin client computing devices/edge computing devices). And while the receiver component 28 may be a stand-alone component (it is shown as such in FIG. 1), in an embodiment, the functionality of the receiver component 28 may be integrated and otherwise incorporated into the workspace analytics system 32.

In an Citrix® ICA embodiment, the functions described for the collector component 22 and the receiver component 28 may be comprise software to implement the functions and methodology described herein and further through use of publicly documented application programming interface (API) calls, as seen by reference to a document entitled Citrix® ICA® Client Object API Specification Programmer's Guide, pgs. 46-48 (“Virtual Channel Support”) dated Jun. 28, 2007 and a further document entitled Citrix® Virtual Channel SDK Programmer Guide, Version 18. The collector and receiver components 22, 28 may establish and use the ICA virtual channel 48 through appropriate interaction with the above-mentioned API's in respect of its Methods, Properties, and Events. Both of the above-mentioned documents are hereby incorporated by reference as though fully set forth herein.

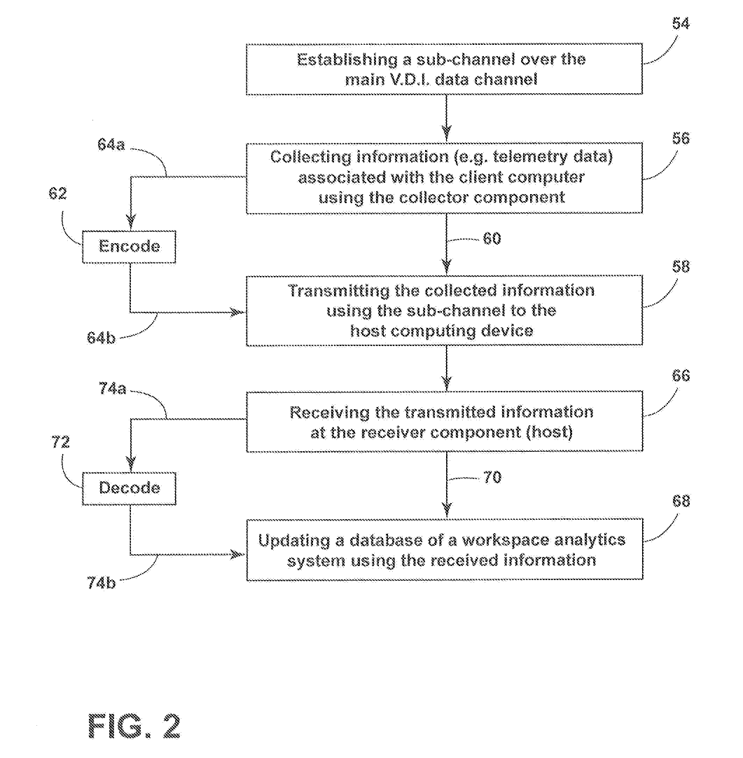

FIG. 2 is a flowchart of a method for collecting and transmitting information associated with the client computing device (e.g., device 12) to a host/server computing device (e.g., device 14) on which is being hosted at least one of an application or a desktop. It should be understood that as an initial matter, the user of the client device 12 establishes a VDI desktop display communication protocol connection (e.g., connection 36 in FIG. 1) from an edge-computing device 12, which may be an edge computer or thin client, to the device 14, which is where the desktop display originates. The device 14 may be a physical computer system or it may be a Virtual Machine (VM), for example running on a Hypervisor such as VMware ESX, Microsoft Hyper-V, Citrix XenServer, or others. The establishment of this VDI connection may be facilitated by means of a so-called VDI connection broker, such as VMware Horizon View or Citrix XenApp. The method begins in step 54.

Step 54 involves establishing a sub-channel 38, such as the above-described ICA virtual channel 48, over the main VDI connection data channel 36. In particular, once the VDI protocol connection has been established by, for example, handshaking by client-side module 20 and host/server-side module 30, the collector component 22 then utilizes this existing communication channel 48 between the client 12 and host/server 14 to create/establish a new, separate sub- or side-channel to the existing communication link for use, among other things, in forwarding collected information about and associated with the client device 12 destined for the workspace analytics system 32.

In an embodiment, establishing the sub-channel may be accomplished by leveraging the VDI communication protocol's own virtual channel functionality, which is responsible for such matters as redirecting device and display input and output to and from the respective devices 12, 14 by establishing separate virtual channels within the established protocol connection for each aspect of such redirection. This will create a new, side-channel virtual channel within the existing communication link, such that information transmitted by the device 12 effectively becomes a part of the existing communication channel already-established between the two devices 12, 14. It should be noted that establishing the VDI communication protocol's communication link (i.e., the VDI data channel 36) between the two devices 12, 14 will have already been configured and appropriately secured by the organization deploying this solution. Thus, creating this new virtual channel avoids the need to address various issues such as network configuration(s), security policies, firewall settings, and the like. Thus, the establishing the virtual channel 48 for purposes of telemetry data transfer does not require any additional infrastructure setup on either end of the connection beyond that already performed to enable/allow the VDI communication protocol connection in the first place. Thus, this approach allows embodiments to establish links between devices that are otherwise ordinarily not reachable by each other outside the aegis of the VDI communication protocol.

On the device 14, the receiver component 28 is configured to detect when the collector component 22 has requested a new side-channel connection over the established VDI protocol communication link 36. The receiver component 28, in response to the detection, makes a connection to the collector component 22 establishing the virtual channel 48 over the main VDI communication protocol's existing communications channel 36. A two-way communication link is formed using the virtual (sub-) channel 48 over the existing VDI protocol channel 36 between the two devices 12, 14. The virtual channel 48 is established within the existing VDI protocol communication link/channel 36 but does not interfere with other VDI-protocol-related channels that may exist within the VDI protocol link/channel 36 that are related to the functionality of providing the remote desktop display, device redirection and other functionality related to the VDI protocol itself.

In an embodiment, the virtual channel 48 may have associated therewith a client-side virtual driver—in effect—that communicates with a server-side application, for example, the receiver component 28/workspace analytics system 32. This virtual driver may be integrated as part of the functionality of the collector component 22. As will be described, when the receiver component 28 has data to send to the collector component 22, such data is sent over the virtual channel 48; however, in an embodiment, the client-side module 20 may be configured to de-multiplex (i.e. extract) the virtual channel data from the VDI stream (i.e., channel 36) and then pass the virtual channel data to the virtual channel driver (i.e., part of the collector component 22). Alternatively, the virtual channel driver may be a separate software component from the herein described collector software component 22. Data transfer in the other direction, namely, from the client device 12 to the host/server device 14 occurs substantially in reverse of the process set forth above. The method proceeds to step 56.

Step 56 involves the collector component 22 collecting information, such as performance and usage data, associated with and about the client device 22. Preliminarily, however, after having established the bidirectional virtual channel 48, the receiver component 28 may first send a ready-to-receive message to the collector component 22 to thereby indicate that the receiver component 28 is ready to receive the information collected by the collector component 22. The collector component 22, after receiving the ready-to-receive message, proceeds to begin gathering information about the client device 12, such as telemetry data (below), which will be sent to the receiver component 28 over the virtual channel 48.

In an embodiment, the telemetry data may be arranged in a number of broad categories, comprising (a) a first category of information related to one or more central processing units (CPU) on the client computing device 12 including (i) CPU load or usage; (ii) CPU or processor type, features and capabilities; and (iii) CPU architecture including whether it is a 32 bit or 64 bit device; (b) a second category of information related to memory usage on the client computing device 12; (c) a third category of information related to one or more network interface modules (NIC) on the client computing device 12 including (i) Internet Protocol (IP) address information comprising a currently configured IP address and netmask; (ii) IP address information of a network gateway device associated with a particular NIC; (iii) a network latency to the local gateway configured on a particular NIC; (d) a fourth category of other information related to the client computing device 12 including (i) a hostname and domain-related information; (ii) an identification of USB and PCI devices and respective capabilities; and (iii) process-related information.

The collector component 22 collects the above-described telemetry data at predefined configurable intervals (i.e., at predefined times). The collection of this data by the collector component 22 is performed in an unobtrusive, impact-neutral fashion which does not otherwise impact or affect the functioning of the device 12. In an embodiment, monitoring/verifying that the data collection is impact-neutral can be evaluated assessing, for example, CPU usage data of the client device 12 in the collected telemetry data.

In an embodiment, the method proceeds to step 58 along path 60 and transmits the collected information (e.g., telemetry data) to the receiver component 28 of device 14 over the previously established virtual channel 48. In an alternate embodiment, however, prior to transmission of the collected information, the collector component 22 encodes, at block 62, the collected information in a format that is independent of platform-specific, transfer-protocol-specific and operating system-specific differences between the two devices 12, 14. This is shown as path segments 64a-64b. For example, to avoid byte ordering and endianness differences between the respective platforms of devices 12, 14, the collected information may be transmitted in a form which has been suitably encoded to negate such differences and to reduce the size of the transmitted data. In an embodiment, the client side collector component 22 is configured to arrange the bits into an order that the receiver component 28 expects to receive, so that any big endian/little endian ordering differences will not cause any incompatibilities or otherwise require conversion. The method proceeds to step 66.

Step 66 involves the receiver component 28 receiving the transmitted (collected) information. The receiver component 28 will decode, at block 72, the encoded (collected) information, following path segments 74a-74b. In other words, the receiver component 28 will suitably decode telemetry information, which may be received in a plurality or stream of packets in a continuous fashion, as received from the collector component 22. The method proceeds to step 68.

Step 68 involves updating the database 33 of the workspace analytics system 32 using the decoded data received from the collector component 22. In an embodiment, the collector component 22 is configured to oversample information (e.g., telemetry data) being collected, as described below. For context, the agent component of the workspace analytics system 32 collects data, in an embodiment, at a customizable time interval. To facilitate analysis of the collected data obtained from a plurality of different computers, the workspace analytics system 32, via the agent component, collects data on synchronized and defined intervals (e.g., 15 seconds). Since the client device 12 and device 14 are independent of each other and loosely coupled in terms of their respective data collection times, the collector component 22 is configured to oversample the information being collected, at a rate that is greater than (i.e., more frequently) that defined in the workspace analytics system 32. The agent component is configured to process the oversampled data into a close approximation of a single dataset synchronized with other collected data, thereby correctly aligning in the database 33 the collected data from the client device 12 with the collected data from other computers.

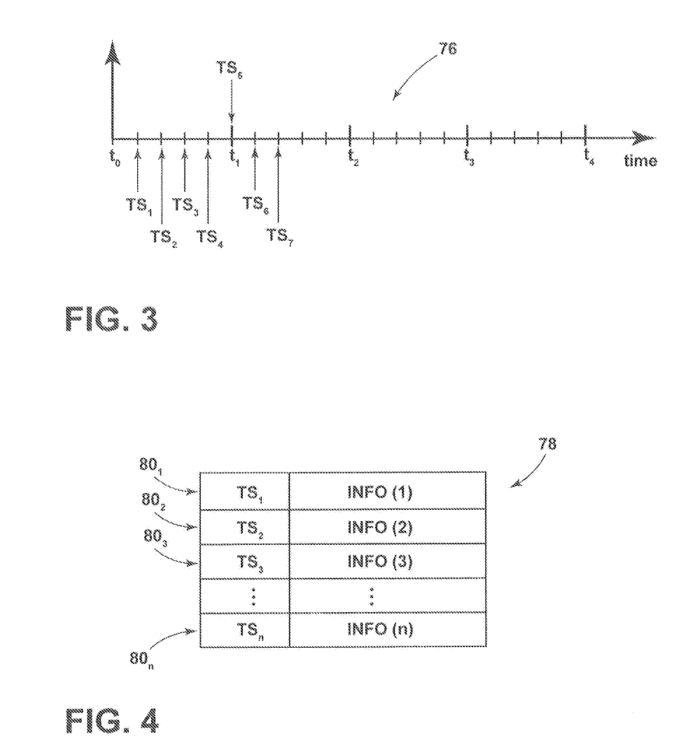

FIGS. 3-4 illustrate the above-described oversampling.

FIG. 3 is a simplified timing diagram 76 illustrating the respective sampling times of the workspace analytics system 32 and the client device 32 (i.e., the collector component 22). First, assume that the workspace analytics system 32 collects data from various, plural computers at predetermined, synchronized times t₀, t₁, t₂, t₃, t₄, . . . . Second, assume that the collector component 22 oversamples information/data to be collected at a higher frequency, for example, at times TS₁, TS₂, TS₃, TS₄, TS₅, TS₆, TS₇, . . . . As shown, the numerous oversampling results in samples that straddle the desired workspace analytics system synchronized collection times, to thereby allow various processing strategies to form a suitable “sample” to store in the database 33 for the client computing device 12.

FIG. 4 is a simplified chart 78 showing how a plurality of collected information (telemetry data) transmissions designated 80₁, 80₂, 80₃, . . . , 80ₙ contain a respective plurality of payload data designated INFO(1), INFO(2), INFO(3), . . . , INFO(n) which have associated therewith a respective timestamp designated TS₁, TS₂, TS₃, . . . , TSₙ. The collected data is transmitted from the client device 12 to the device 14, wherein the receiver component 28 may processes the plurality of data transmissions 80₁, 80₂, 80₃, . . . , 80ₙ in order to arrive at a close approximation, as described above.

Synchronization Strategy.

In an embodiment, the collecting of information by the collector component 22 is done at a frequency, as an initial matter, that is requested by the receiver component 28, which may be by default a relatively fast rate as compared to the workspace analytics system 32 (e.g., once per second as compared to once every 15 seconds). The collector component 22 transmits the collected data (i.e., the transmissions) at this oversampling rate wherein each transmission is timestamped with a respective collection time. The receiver component 28, in an embodiment, may be configured to average the collected data as continuously received over a desired reporting period, in order to match the time interval at which the workspace analytics system 32 samples data. The receiver component 28 then interacts with the agent component of system 32, which is configured to effect storing of the averaged data transmissions to the database 33 at a time that matches the normal collection time of the agent component (i.e., 15 second interval). In an embodiment, the collector component 22 oversamples at a rate between about three and fifteen times that followed by the workspace analytics system 32.

After the averaged collected data has been stored in the database 33, the analytical tools in the workspace analytics system 32 can now be used to visualize and otherwise utilize the collected client device data to provide meaningful information regarding the performance and usage of the client device 12 as well as to investigate and diagnose faults, if any. It should be understood that the operation of the receiver component 28 on the device 14 is performed in an unobtrusive, impact-neutral fashion which does not otherwise impact or affect the functioning of the device 14.

Embodiments consistent with the present disclosure allow a workspace analytics system 32 to analyze telemetry data from computing devices that would not otherwise be capable of supporting the collection, processing, and transmission of telemetry data to workspace analytics system, due to capability/processing limitations.

With continued reference to FIG. 2, the method then proceeds forward from step 68. Although not shown expressly in FIG. 2, as long as the communication link/channel 36 remains active between the client device 12 and the host/server device 14 and the receiver component 28 continues to indicate availability to receive data (e.g., by continuing to send ready-to-receive messages over the virtual channel 48 to collector component 22), the collector component 22 will continue to operate and collect and transmit such collected information to the receiver component 28.

Since the virtual channel 48 between the collector component and the receiver component 28 is established within the existing VDI protocol link (i.e., the link/channel 36) but does not otherwise interfere with other channels within the VDI protocol link, for example, as related to the remote desktop display and device redirection, the collector component 22 and the receiver component 28 may be configured to open or close the virtual channel 48 between each other without affecting the rest of the information flowing over the VDI communication protocol channel 36 between the two devices 12, 14. Finally, the collector component 22 and the receiver component 28 are, in an embodiment, agnostic to the platform and operating system installed on the respective devices 12, 14 and are configured to operate on a wide variety of common hardware platforms and operating systems.

It should be understood that an electronic processor as described herein may include conventional processing apparatus known in the art, capable of executing pre-programmed instructions stored in an associated memory, all performing in accordance with the functionality described herein. To the extent that the methods described herein are embodied in software, the resulting software can be stored in an associated memory and can also constitute the means for performing such methods. Implementation of certain embodiments, where done so in software, would require no more than routine application of programming skills by one of ordinary skill in the art, in view of the foregoing enabling description. Such an electronic processor may further be of the type having both ROM, RAM, a combination of non-volatile and volatile (modifiable) memory so that any software may be stored and yet allow storage and processing of dynamically produced data and/or signals.

It should be further understood that an article of manufacture in accordance with the present disclosure includes a computer-readable storage medium having a computer program encoded thereon for implementing the disclosed collector component and receiver component and other functionality described herein. The computer program includes code to perform one or more of the methods disclosed herein. Such embodiments may be configured to execute one or more processors, multiple processors that are integrated into a single system.

Although only certain embodiments have been described above with a certain degree of particularity, those skilled in the art could make numerous alterations to the disclosed embodiments without departing from the scope of this disclosure. Additionally, the terms “electrically connected” and “in communication” are meant to be construed broadly to encompass both wired and wireless connections and communications. It is intended that all matter contained in the above description or shown in the accompanying drawings shall be interpreted as illustrative only and not limiting. Changes in detail or structure may be made without departing from the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While one or more particular embodiments have been shown and described, it will be understood by those of skill in the art that various changes and modifications can be made without departing from the spirit and scope of the present teachings.

What is claimed is:

1. A method for collecting and transmitting information associated with a client computing device to a host computing device on which at least one of an application and a desktop is hosted for rendering on the client computing device by way of data transmitted to the client computing device over a data channel, the method comprising:
establishing a sub-channel associated with the data channel for communication between the client computing device and the host computing device;
collecting information associated with the client computing device at predetermined times;
transmitting the collected information from the client computing device using the sub-channel to the host computing device;
receiving the transmitted information at the host computing device; and
updating a database of a workspace analytics system using the received information.

2. The method of claim 1 wherein the data channel is established according to a virtual desktop infrastructure (VDI) desktop display communication protocol, and wherein establishing the sub-channel associated with the data channel comprises:
after establishing the data channel, requesting, using a collector component executing on the client computing device, that the sub-channel be established over the established data channel; and
detecting the request for the sub-channel using a receiver component executing on the host computing device.

3. The method of claim 2 further comprising:
sending a message from the receiver component to the collector component using the sub-channel indicating that the receiver component is ready to receive collected information.

4. The method of claim 3 wherein the collecting information occurs after the collector component receives the message from the receiver component.

5. The method of claim 1 wherein at least a portion of data in the database of the workspace analytics system associated with a plurality of computers is collected at synchronized and predefined sampling time intervals, and wherein the collecting information at predetermined times further comprises:
oversample the collecting of information relative to the predefined sampling time interval associated with the data in the workspace analytics system database.

6. The method of claim 5 further comprising processing a plurality of the oversampled received information into a single dataset having an effective sampling time synchronized with and aligned to one of said predefined sampling time intervals.

7. The method of claim 5 wherein the collecting of information occurs at least three times more frequently than the predefined sampling time interval of the workspace analytics system.

8. The method of claim 1 wherein the collected information associated with the client computing device comprises telemetry data.

9. The method of claim 6 wherein the telemetry data includes at least one category selected from the group comprising (a) a first category of information related to one or more central processing units (CPU) on the client computing device including (i) CPU load or usage; (ii) CPU type, features and capabilities; and (iii) CPU architecture including a processing bit depth of 32 bit or 64 bit; (b) a second category of information related to memory usage on the client computing device; (c) a third category of information related to one or more network interface modules (NIC) on the client computing device including (i) Internet Protocol (IP) address information comprising a currently configured IP address and netmask; (ii) IP address information of a network gateway device associated with a particular NIC; (iii) a network latency to the local gateway configured on a particular NIC; (d) a fourth category of other information related to the client computing device including (i) a hostname and domain-related information; (ii) an identification of USB and PCI devices and respective capabilities; and (iii) process-related information.

10. The method of claim 1 further comprising:
before transmitting from the client computing device, encoding the collected information in accordance with a predetermined encoding strategy using the collector component; and
after receiving the transmitted information at the host computer device, decoding the encoded information.

11. The method of claim 3 further comprising repeatedly sending the message from the receiver component indicating that the receiver component is ready to receive collected information.

12. The method of claim 11 wherein the collector component of the client computing device continues to collect and transmit information so long as the established sub-channel remains active and the receiver component continues to indicate readiness to receive collected data by virtue of sending the messages.

13. The method of claim 1 further comprising:
disconnecting the sub-channel.

14. The method of claim 2 wherein the VDI communication protocol is selected from the group comprising (i) Independent Computing Architecture (ICA) protocol; (ii) Remote Desktop Protocol (RDP)/Remote Desktop Services; (iii) Personal Computer over Internet Protocol (PColP); and (iv) Blast or Blast Extreme Display protocol.

15. The method of claim 14 wherein the selected protocol comprises the ICA protocol and wherein the sub-channel comprises an ICA Virtual Channel.

16. In a system including a client computing device and a host computing device on which at least one of an application and a desktop is hosted for rendering on the client computing device by way of data transmitted to the client computing device over a data channel according to a virtual desktop infrastructure (VDI) desktop display communication protocol, an apparatus configured to collect and transmit information associated with the client computing device to the host computing device, comprising:
a first electronic processor and a first memory in the client computing device;
a collector component stored in the first memory which when executed by the first processor is configured to:
establish a sub-channel associated with the data channel for communication between the client computing device and the host computing device;
collect information associated with the client computing device at predetermined times; and
transmit the collected information from the client computing device using the sub-channel to the host computing device; and
a second electronic processor and a second memory in the host computing device;
a receiver component stored in the second memory which when executed by the second processor is configured to:
receiving the transmitted information at the host computing device; and
updating a database of a workspace analytics system using the received information.

17. The apparatus of claim 16 wherein the data channel is established according to a virtual desktop infrastructure (VDI) desktop display communication protocol, and the collector component and the receiver component are configured to establish the sub-channel over the established data channel.

18. The apparatus of claim 16 wherein at least a portion of data in the database of the workspace analytics system is associated with a plurality of computers and is collected at synchronized and predefined sampling time intervals, wherein the collector component is configured to oversample the collecting of information relative to the predefined sampling time interval.

19. The apparatus of claim 18 wherein the receiver component is configured to process a plurality of the oversampled received information into a single dataset having an effective sampling time synchronized with and aligned to one of the predefined sampling time intervals.

20. The apparatus of claim 16 wherein the collected information associated with the client computing device comprises telemetry data.

21. The apparatus of claim 16 wherein the collector component is configured to encode the collected information in accordance with a predetermined encoding strategy before transmitting over the sub-channel; and
wherein the receiver component is configured to decode the encoded information transmitted by the collector component.

22. The apparatus of claim 17 wherein the VDI) communication protocol is selected from the group comprising (i) Independent Computing Architecture (ICA) protocol; (ii) Remote Desktop Protocol (RDP)/Remote Desktop Services; (iii) Personal Computer over Internet Protocol (PColP); and (iv) Blast or Blast Extreme Display protocol.

23. The apparatus of claim 22 wherein the selected protocol comprises the ICA protocol and wherein the sub-channel comprises an ICA Virtual Channel.
